(19) United States
(12) Patent Application Publication
(10) Pub. No.: US 2011/0209884 A1
(43) Pub. Date: Sep. 1, 2011

(54) FIRE-EXTINGUISHING METHOD AND APPARATUS

(76) Inventor: Göran Sundholm, Tuusula (FI)

(21) Appl. No.: 12/739,983

(22) PCT Filed: Oct. 28, 2008
(86) PCT No.: PCT/FI08/50606

§ 371 Date: Apr. 27, 2010

(30) Foreign Application Priority Data
Oct. 29, 2007 (FI) 20075762

(51) Int. Cl. A62C 2/00; A62C 35/00

(52) U.S. Cl. 169/46; 169/16

(57) ABSTRACT

A method in the fire protection of an area, in which in the area are arranged several fire extinguishing spraying heads (1) which, when activated, spray extinguishing medium in the area, and between which adjacent spraying heads there is a spacing (S1, S2). The spraying heads (1) are arranged in the area (A1, A2) by defining a water flux density of extinguishing medium required for protecting the area being protected and by defining feed pressure (p1, p2) of extinguishing medium for the spraying heads (1) of a certain area or section of an area, whereby the spacing (S1, S2) of adjacent spraying heads depends on the magnitude of the feed pressure (p1, p2) and a K value of the spraying head so that the water flux density of extinguishing medium intended for spraying is substantially constant. The invention also relates to an apparatus.

### BACKGROUND OF INVENTION

The invention relates to a method in the fire-protection of an area according to the preamble of claim 1.

The invention also relates to a fire-extinguishing apparatus according to the preamble of claim 10.

Sprinkler installations are conventionally dimensioned such that a water flux density in an area being protected or in the whole building being protected is at least a given limit value when sprinklers have been triggered for the extent of a specific area of operation. In Europe, the limit value of extinguishing medium flux density, particularly water flux density, is 5 mm/min (=5 l/min/m²) in normal sprinkler class (OH) targets. The area of operation depends on the group of the sprinkler class and is at its minimum 72 m² and at its maximum 360 m². Furthermore, for conventional sprinklers have been defined a maximum sprinkler-specific protection area and a maximum spacing from the next sprinkler. In practice, these boundary conditions mean that the water flux density realised far from the water source (great pressure loss−low nozzle pressure) is the required minimum value, whereas the water flux density realised close to the water source (small pressure loss−high nozzle pressure) is a lot higher than the required limit value. Thus, “too much” water is sprayed close to the water source, which is technically and cost-effectively disadvantageous, because the water source has to be dimensioned in accordance with this highest flow.

The object of this invention is to achieve a totally novel solution whereby the disadvantages of known prior art are avoided. An object of the invention is to provide a method for fire protection, by means of which it is possible to better utilise differences between the various parts of the extinguishing system in feed pressures of spraying heads. On the other hand, an object is to achieve a fire protection system by means of which it is possible to optimise the number of required spraying heads and the throughput of pipelines feeding extinguishing medium to them.

The invention is based on an idea in which spacings between the spraying heads of the fire-extinguishing system are arranged unequal in different protected areas or sections of the system, depending on the pressure of the extinguishing medium at an in-feed point of each area or section, when simultaneously the sprayed water flux density is substantially kept constant.

A method according to the invention is mainly characterised in that spraying heads are arranged in an area by defining a water flux density required for protecting the area being protected and by defining feed pressure of extinguishing medium for the spraying heads of a certain area or section of an area, whereby a spacing of adjacent spraying heads depends on the magnitude of feed pressure and a K value of the spraying head so that the water flux density of extinguishing medium intended for spraying is substantially constant.

In addition, the method according to the invention is characterised by what is stated in claims 2-8.

An apparatus according to the invention is characterised in that adjacent spraying heads are arranged in relation to each other at a spacing which is dependent on feed pressure of an extinguishing means to the spraying head in the activated mode of the system when a water flux density intended for spraying is substantially constant.

The apparatus according to the invention is further characterised by what is stated in claims 10-14.

The arrangement according to the invention has numerous significant advantages. With the method according to the invention, the water flux density in the whole target can be dimensioned close to the required minimum value, whereby the number of nozzles and the size of the water source are minimised. With the method and apparatus according to the invention, the diameters of pipes used in feeding extinguishing means can also be kept small. By making the spacings of adjacent spraying heads dependent on the feed pressure of extinguishing medium, the spacings between the spraying heads can be increased from the recent way in which the same standard spacing is used between the spraying heads in different parts of the system. There is particularly a lot of advantage of the method and apparatus according to the invention with small operating pressures of spraying heads, because the sprayed water volume is proportional to the square root of feed pressure. By using spraying heads which spray medium mist, the volume of extinguishing medium can be kept small, whereby the number of damages caused by the extinguishing medium, such as water damages, is considerably small compared to conventional water-spray extinguishing. The arrangement according to the invention is not suitable in connection with conventional nozzles used in a fire-extinguishing apparatus, in which when spraying pressure increases, the spacing between the nozzles decreases, because their extinguishing medium spray typically narrows along with the increase of spraying pressure. The advantages of the arrangement according to the invention are particularly acquired with spraying heads in which the spray remains substantially at the same extent or expands along with the increase of spraying pressure.

Here, fire protection mainly refers to decreasing the harms of fire, such as extinguishing fire, smothering fire or controlling fire.

### BRIEF DESCRIPTION OF FIGURES

Next, the invention will be described in detail by means of an example with reference to the accompanying drawing in which

FIG. 1 schematically shows an arrangement according to the invention and a top view of the location of spraying heads, and

FIG. 2 shows a graphic chart on the change of a spacing between adjacent spraying heads when pressure of extinguishing medium changes in a situation according to an example and the number of spraying heads in an area conformable to “Ordinary Hazard 1” (OH1) with various values of pressure of extinguishing medium.

### DETAILED DESCRIPTION OF INVENTION

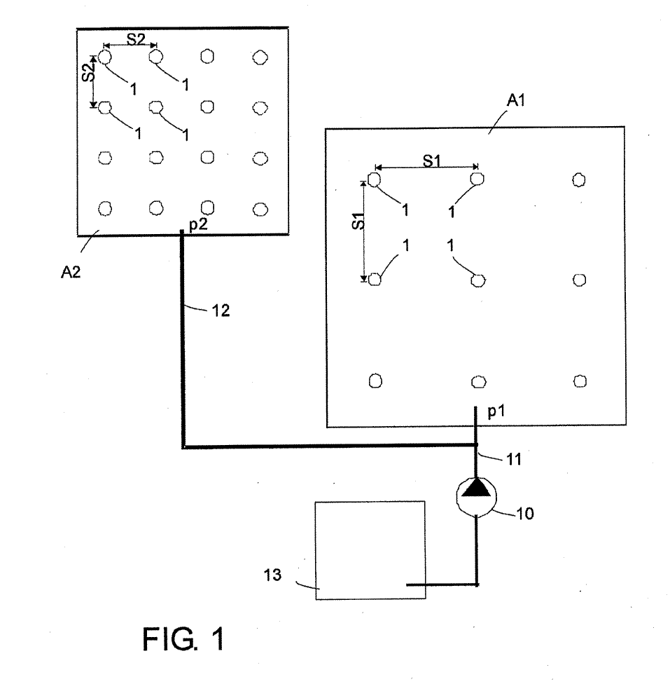

FIG. 1 shows a simplified extinguishing system which utilises an arrangement according to the invention. The figure shows a top view of two areas, a first area A1 and a second area A2, in which spraying heads 1 mutually substantially similar intended for fire extinguishing have been used. The first area A1 is hydraulically considered, typically also measured by spacing, at a shorter spacing away from feed means of extinguishing medium of the system, such as a pump means 10 and an extinguishing medium source 13. When the system has activated, the pump means 10 feeds extinguishing medium along a feed pipe 11 to the spraying heads 1 of the first area A1. Parts of the feed line of the extinguishing system going from the feed pipe 11 to the spraying heads 1 have been omitted from FIG. 1 for clarity. These are assumed evident to those skilled in the art. Feed pressure of the spraying heads of the first area A1 is designated with reference p1 in the figure. Spacings between the adjacent spraying heads 1 of the first area A1 are designated with reference S1 in the figure.

The second protected area A2 is hydraulically considered, typically also measured by spacing, at a longer spacing away from the feed means of extinguishing medium, such as the pump means 10 and the extinguishing medium source 13, than the first protected area A1. When the system has activated, the pump means 10 feeds extinguishing medium along feed pipes 11, 12 to the spraying heads 1 of the second area A2. Parts of the feed line going from the feed pipe 12 to the spraying heads of the second area A2 have been omitted from the figure for clarity. Feed pressure of the spraying heads 1 of the second area A2 is designated with reference p2 in the figure. Spacings between the adjacent spraying heads 1 of the second area A2 are designated with reference S2 in the figure.

In the example according to the figure, the protected areas have been protected conformable to the so-called “Ordinary Hazard Group 1” (OH1) requirements. In the described example, spraying heads provided with mutually similar characteristics have been used for clarity. K values of the spraying heads 1 are mutually constant. The characteristics of the spraying heads 1 are further such that, with high values of feed pressure p1, p2 of extinguishing medium, they can spray extinguishing medium substantially at least in an equivalent surface, advantageously in a larger surface, than with lower feed pressures of extinguishing medium. From the viewpoint of the invention, it is thus substantial that with the spraying heads, if required, it is possible to spray extinguishing medium on the whole in a large enough surface with all combinations of feed pressure and installation spacing. (With conventional nozzles, the spray typically narrows as the pressure increases, whereby the installation spacing cannot be increased when the pressure increases.) In the example according to the invention, the water flux density (mm/min) of extinguishing medium sprayed to the protected areas A1, A2 has been tried to keep constant irrespective of the differences between the feed pressure p1 of the first area A1 and the feed pressure p2 of the second area A2.

The example according to FIG. 1 illustrates a situation in which a calculated first feed pressure p1 of the first area A1 is higher than a calculated second feed pressure p2 of the second area A2.

In practice in recent arrangements, the extinguishing system of both areas, the first area A1 and the second area A2, would have been installed within predetermined limits, substantially according to the spacings S2 between adjacent spraying heads given by the lowest calculated feed pressure p2. Then, a considerable number of non-required spraying heads would have been installed in the first area 1 and the sprayed water flux density in the area A1 would also have been unnecessarily high. It would have also required larger pipelines of their throughput, particularly of their diameter.

According to the invention, it has been however observed that, when using extinguishing medium mist, particularly water mist, as the extinguishing medium and by utilising spraying heads intended for spraying extinguishing medium mist, the overdimensioning of the extinguishing medium system can be avoided. At the same time, the number of required spraying heads can be considerably decreased and smaller pipelines of their throughput used.

In the situation of FIG. 1, an embodiment of the invention has been utilised, in accordance with which in the area A1 of the higher feed pressure p1 it is possible to use substantially larger spacings S1 between adjacent spraying heads 1, compared to, hydraulically considered, the spacings between the spraying heads 1 of the second area A2 being farther, in which the feed pressure p2 of extinguishing medium has lowered, inter alia, due to pressure losses of the feed piping. However, the volume of sprayed extinguishing medium mist per time unit per surface is in both areas A1 and A2 substantially equal. Therefore in the example of FIG. 1, it has been possible to use in the first protected area A1 larger spacings S1 between adjacent spraying heads 1 with pressure p1 than with the spraying heads 1 in the protected second area A2 provided with an equal K value where the feed pressure p2 is lower than in the area A1. In the example, nine spraying heads have been arranged to protect the first area and sixteen spraying heads to protect the second area.

### Example 1

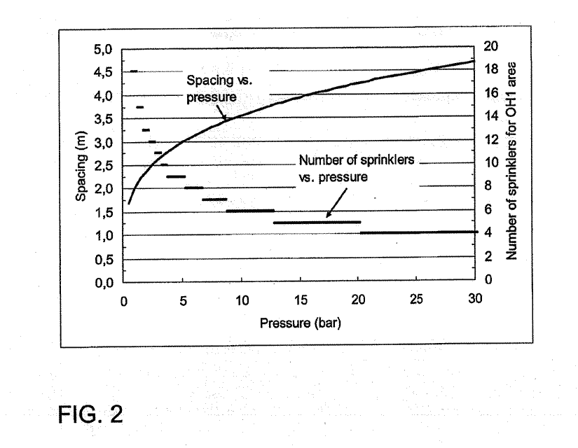

Table 1 and FIG. 2 illustrate a further embodiment of the invention by means of an example. The example employs a spraying head the K value of which is 20. The water flux density (flux) sprayed in the area is substantially kept constant the value being 5 mm/min. The feed pressure p of the spraying heads is changed, whereby calculatorily is obtained the spacing S between adjacent spraying heads. This is obtained by utilising the formula Q=k(p)^{1/2}. Q is volume flow (l/min), p is feed pressure (bar) and k is the so-called K value of the nozzle. Furthermore in Table 1, the number of required spraying heads in an area of a 72 square metre surface with different values of feed pressure has been defined. The protection requirements of the area are conformable to the European sprinkler standard “Ordinary Hazard Group 1” (OH1).

TABLE 1

| | Water flux density of | | Spacing (m) | Number (no.) of spraying |
|---|---|---|---|---|
| | extinguishing medium | Feed | between adjacent | heads when area surface is |
| K value of | sprayed in area | pressure | spraying heads | 72 m² and protection |
| spraying head | flux. | p | spacing | requirement OH1 |
| k | (mm/min) | (bar) | (m) | (no.) |
| 20 | 5 | 0.5 | 1.68 | 26 |
| 20 | 5 | 1.0 | 2.00 | 18 |
| 20 | 5 | 1.5 | 2.21 | 15 |
| 20 | 5 | 2.0 | 2.38 | 13 |
| 20 | 5 | 2.5 | 2.51 | 12 |
| 20 | 5 | 3.0 | 2.63 | 11 |
| 20 | 5 | 3.5 | 2.74 | 10 |
| 20 | 5 | 4.0 | 2.83 | 9 |
| 20 | 5 | 4.5 | 2.91 | 9 |
| 20 | 5 | 5.0 | 2.99 | 9 |
| 20 | 5 | 5.5 | 3.06 | 8 |
| 20 | 5 | 6.0 | 3.13 | 8 |
| 20 | 5 | 6.5 | 3.19 | 8 |
| 20 | 5 | 7.0 | 3.25 | 7 |
| 20 | 5 | 7.5 | 3.31 | 7 |
| 20 | 5 | 8.0 | 3.36 | 7 |
| 20 | 5 | 8.5 | 3.41 | 7 |
| 20 | 5 | 9.0 | 3.46 | 6 |
| 20 | 5 | 9.5 | 3.51 | 6 |
| 20 | 5 | 10.0 | 3.56 | 6 |
| 20 | 5 | 10.5 | 3.60 | 6 |
| 20 | 5 | 11.0 | 3.64 | 6 |
| 20 | 5 | 11.5 | 3.68 | 6 |
| 20 | 5 | 12.0 | 3.72 | 6 |
| 20 | 5 | 12.5 | 3.76 | 6 |
| 20 | 5 | 13.0 | 3.80 | 5 |
| 20 | 5 | 13.5 | 3.83 | 5 |
| 20 | 5 | 14.0 | 3.87 | 5 |
| 20 | 5 | 14.5 | 3.90 | 5 |
| 20 | 5 | 15.0 | 3.94 | 5 |
| 20 | 5 | 15.5 | 3.97 | 5 |
| 20 | 5 | 16.0 | 4.00 | 5 |
| 20 | 5 | 16.5 | 4.03 | 5 |
| 20 | 5 | 17.0 | 4.06 | 5 |
| 20 | 5 | 17.5 | 4.09 | 5 |
| 20 | 5 | 18.0 | 4.12 | 5 |
| 20 | 5 | 18.5 | 4.15 | 5 |
| 20 | 5 | 19.0 | 4.18 | 5 |
| 20 | 5 | 19.5 | 4.20 | 5 |
| 20 | 5 | 20.0 | 4.23 | 5 |
| 20 | 5 | 20.5 | 4.26 | 4 |
| 20 | 5 | 21.0 | 4.28 | 4 |
| 20 | 5 | 21.5 | 4.31 | 4 |
| 20 | 5 | 22.0 | 4.33 | 4 |
| 20 | 5 | 22.5 | 4.36 | 4 |
| 20 | 5 | 23.0 | 4.38 | 4 |
| 20 | 5 | 23.5 | 4.40 | 4 |
| 20 | 5 | 24.0 | 4.43 | 4 |
| 20 | 5 | 24.5 | 4.45 | 4 |
| 20 | 5 | 25.0 | 4.47 | 4 |
| 20 | 5 | 25.5 | 4.49 | 4 |
| 20 | 5 | 26.0 | 4.52 | 4 |
| 20 | 5 | 26.5 | 4.54 | 4 |
| 20 | 5 | 27.0 | 4.56 | 4 |
| 20 | 5 | 27.5 | 4.58 | 4 |
| 20 | 5 | 28.0 | 4.60 | 4 |
| 20 | 5 | 28.5 | 4.62 | 4 |
| 20 | 5 | 29.0 | 4.64 | 4 |
| 20 | 5 | 29.5 | 4.66 | 4 |
| 20 | 5 | 30.0 | 4.68 | 4 |

From Table 1 and FIG. 2, it can be observed that with pressure values 20.5-30 bar only four spraying heads according to the example are required in the area in question. With low pressures, the number of spraying heads required for protecting the area increases to manifold. For example with feed pressure 1.0 bar, eighteen spraying heads according to the example are required. The spacing between the spraying heads of the Table are shown in FIG. 2 with a continuous graph. The numbers of required spraying heads are shown by pressure ranges with another graph. From FIG. 2 and Table 1, it is observed that, with the values of the example, considerable savings of spraying volumes are achieved particularly with low pressures which are in the example 0.5-12.5 bar. It should be noted that with some other starting values the result could be different.

The feed of medium in the spraying heads is arranged in a way known as such with pipelines. In the pipelines are typically arranged required stopper/regulation elements, such as valve elements, which open the access of the medium in each pipe branch according to the requirements of the target of application.

The system can comprise a detector means, such as a fire, smoke or heat detector, based on an impulse conveyed by which the operation of the system is controlled. The system can also comprise spraying heads provided with a triggering means, such as a heat-sensitive ampoule.

In feeding extinguishing medium, low pressure and/or intermediate pressure and/or high pressure can be used. Low pressure refers to in this context mainly pressures which are below about 12 bar. Intermediate pressure refers to pressures which are higher than about 12 bar and lower than about 35 bar. High pressure refers to pressures which are above about 35 bar. According to an advantageous embodiment, the high pressure range typically extends until the pressure of about 300 bar.

When utilising the invention, it is possible to use spraying heads which are able to form and spray medium mist in an adequately extensive surface with quite low feed pressures of extinguishing medium and/or intermediate feed pressures and/or high feed pressures of extinguishing medium. A such spraying head which operates both with feed pressures of intermediate range and with feed pressures of low range is described in specification WO2006064082, equivalent Finnish patent FI116661B. With high feed pressures, it is possible to utilise e.g. spraying heads spraying mist in large areas by Marioff Corporation Oy, such as e.g. the spraying head described in specification WO0145799.

As the extinguishing medium, liquid, such as aqueous extinguishing medium, such as water, and/or water with additive which intensifies extinguishing, and/or a mixture of liquid and gas is utilised. The extinguishing medium mist utilised is typically liquid or a mixture of liquid and gas.

The liquid mist provided with the nozzles can be extremely fine. The drop size (Dv90) is typically below 400 micrometres. Depending on the target of application, the drop size can also be larger.

FIG. 1 also shows schematically and simplified the extinguishing medium source 13. The pump device 10 is connected to the extinguishing medium source 16. Instead of the pump device or in addition to it, some other suitable pressure source can be utilised, such as pressure tanks, by means of the pressure of which extinguishing medium is conveyed to the spraying head at least in a fire situation.

In the invention, it is possible to use a so-called booster pump in the feed line 11, 12, whereby it is possible to use smaller pipelines 11, 12 of their throughputs, the diameter of which is smaller, and the pressure losses for their part are greater. Then, it is possible to keep the feed pressures of the spraying heads higher also farther from the actual feed means 10, 13 and a smaller number of spraying heads is required.

The invention thus relates also to a method in the fire protection of an area, in which in the area are arranged several fire extinguishing spraying heads 1 which, when activated, spray extinguishing medium in the area, and between which adjacent spraying heads there is a spacing S1, S2. The spraying heads 1 are arranged in the area A1, A2 by defining the spraying volume of extinguishing medium per time unit per surface required for protecting the area being protected and by defining the feed pressure p1, p2 of extinguishing medium for the spraying heads 1 of a certain area or section of an area, whereby the spacing S1, S2 of adjacent spraying heads depends on the magnitude of feed pressure p1, p2 and a K value of the spraying head so that a water flux density of extinguishing medium intended for spraying is substantially constant. According to an advantageous embodiment of the method according to the invention, the spraying head 1 is arranged to spray extinguishing medium with higher feed pressure p1 at least in an equivalent area or a larger area than with lower feed pressure p2.

According to an embodiment of the invention, in the method, in connection with the lower feed pressure p2 of extinguishing medium is used the smaller spacing S2 between adjacent spraying heads and in connection with the higher feed pressure p1 of extinguishing medium is used the larger spacing S1 between adjacent spraying heads.

According to an embodiment of the invention, spraying heads mutually substantially similar of their K value are used.

According to a further embodiment, the feed pressure p1 of the spraying heads 1 of the first protected area A1 or section being higher than the feed pressure p2 of the spraying heads of the second protected area A2 or section, a smaller number of spraying heads is used for the protection of the first area A1 or section, when the volume of extinguishing medium sprayed when activated in the area per time unit per surface is kept constant.

According to an embodiment of the invention, in the method, extinguishing medium mist is sprayed as the extinguishing medium with spraying heads 1.

The protected area can particularly be an area in Class I of the European sprinkler standard Ordinary Hazard (OH1). The invention can also be utilised in targets conformable to other standards and protection classes.

According to a typical embodiment, pressure, which is 2-300 bar, is used in feeding the extinguishing medium.

Liquid or a mixture of liquid and gas is utilized as the extinguishing medium.

The invention also relates to a fire-extinguishing apparatus which comprises spraying heads 1 arranged in a protected area and means for conveying extinguishing medium to the spraying heads. Adjacent spraying heads are arranged in relation to each other at a spacing S1, S2 which is dependent on the feed pressure p1, p2 of the extinguishing means to the spraying head in the activated mode of the system when a water flux density intended for spraying is substantially constant.

An embodiment of the system comprises at least two areas or sections intended for protection, in which for spraying heads 1 of a first area A1 is arranged first feed pressure p1 of extinguishing medium and for spraying heads 1 of a second area A2 or section is arranged second feed pressure p2 of extinguishing medium, and that adjacent spraying heads of the first area or section are arranged in relation to each other at a spacing S1 and that the spraying heads of the second area A2 or section are arranged in relation to each other at a spacing S2, whereby the spacing S1, S2 depends on feed pressure p1, p2 when the water flux density of extinguishing medium intended for spraying is substantially constant.

According to a typical embodiment, a K value of the spraying heads 1 is substantially constant.

According to an advantageous embodiment, the spraying head 1 is arranged to spray extinguishing medium mist with high feed pressure at least substantially in an equivalent surface or a larger surface than with lower feed pressure.

The spraying heads are arranged to spray extinguishing medium mist. The extinguishing medium is liquid or a mixture of liquid and gas.

It is obvious to those skilled in the art that the invention is not limited to the embodiments described above, but it may be varied within the scope of the enclosed claims. Characteristic features presented in the specification, mentioned in combination with each other may also be independent characteristic features.

1. A method in the fire protection of an area, in which in the area are arranged several fire extinguishing spraying heads (1) which, when activated, spray extinguishing medium to the area, and between which adjacent spraying heads there is a spacing (S1, S2), characterised in that the spraying heads (1) are arranged in the area (A1, A2) by defining a water flux density of extinguishing medium required for protecting the area being protected and by defining feed pressure (p1, p2) of extinguishing medium for the spraying heads (1) of a certain area or section of an area, whereby the spacing (S1, S2) of adjacent spraying heads depends on the magnitude of the feed pressure (p1, p2) and a K value of the spraying head so that the water flux density of extinguishing medium intended for spraying is substantially constant.

2. A method according to claim 1, characterised in that the spraying head (1) is arranged to spray extinguishing medium with higher feed pressure (p1) at least in an equivalent surface or a larger surface than with lower feed pressure (p2).

3. A method according to claim 1, characterised in that, in the method, in connection with the lower feed pressure (p2) of extinguishing medium is used a smaller spacing (S2) between adjacent spraying heads and in connection with the higher feed pressure (p1) of extinguishing medium is used a larger spacing (S1) between adjacent spraying heads.

4. A method according to claim 1, characterised in that spraying heads mutually substantially similar of their K value are used.

5. A method according to claim 1, characterised in that the feed pressure (p1) of the spraying heads (1) of the first protected area (A1) or section being higher than the feed pressure (p2) of the spraying heads of the second protected area (A2) or section, a smaller number of spraying heads is used for the protection of the first area (A1) or section when the water flux density of extinguishing medium sprayed when activated in the area is kept constant.

6. A method according to claim 1, characterised in that extinguishing medium mist is sprayed as the extinguishing medium with the spraying heads (1).

7. A method according to claim 1, characterised in that pressure, which is 2-300 bar, is used in feeding the extinguishing medium.

8. A method according to claim 1, characterised in that as the extinguishing medium is used liquid or a mixture of liquid and gas.

9. A fire-extinguishing apparatus, which comprises spraying heads (1) arranged in an area being protected and means for conveying extinguishing medium to the spraying heads, characterised in that adjacent spraying heads are arranged in relation to each other at a spacing (S1, S2) which is dependent on feed pressure (p1, p2) of extinguishing means in the activated mode of the system when a water flux density of extinguishing medium intended for spraying is substantially constant.

10. A fire-extinguishing apparatus according to claim 9, characterised in that the system comprises at least two areas or sections intended for protection, in which for spraying heads (1) of a first area (A1) is arranged first feed pressure (p1) of extinguishing medium and for spraying heads (1) of a second area (A2) or section is arranged second feed pressure (p2) of extinguishing medium, and that adjacent spraying heads of the first area or section are arranged in relation to each other at a spacing (S1) and that the spraying heads of the second area (A2) or section are arranged in relation to each other at a spacing (S2), whereby the spacing (S1, S2) depends on the feed pressure (p1, p2) when the water flux density of extinguishing medium intended for spraying is substantially constant.

11. A fire-extinguishing apparatus according to claim 9, characterised in that a K value of the spraying heads is substantially constant.

12. A fire-extinguishing apparatus according to claim 9, characterised in that the spraying heads are arranged to spray extinguishing medium mist.

13. A fire-extinguishing apparatus according to claim 9, characterised in that the spraying head (1) is arranged to spray extinguishing medium mist with high pressure at, least in an equivalent surface or a larger surface than with lower pressure.

14. A fire-extinguishing apparatus according to claim 9, characterised in that the extinguishing medium is liquid or a mixture of liquid and gas.
